(19) United States
(12) Patent Application Publication
(10) Pub. No.: US 2025/0329497 A1
(43) Pub. Date: Oct. 23, 2025

(54) MULTILAYER CERAMIC CAPACITOR

(71) Applicant: Murata Manufacturing Co., Ltd., Nagaokakyo-shi (JP)

(72) Inventors: Akira ISHIZUKA, Nagaokakyo-shi (JP); Akira TANAKA, Nagaokakyo-shi (JP)

(21) Appl. No.: 19/251,874

(22) Filed: Jun. 27, 2025

Related U.S. Application Data
(63) Continuation of application No. PCT/JP2023/041870, filed on Nov. 21, 2023.

(30) Foreign Application Priority Data
Dec. 28, 2022 (JP) 2022-212598

(51) Int. Cl. H01G 4/012; H01G 4/248; H01G 4/30

(52) U.S. Cl. CPC H01G 4/012; H01G 4/248; H01G 4/30

(57) ABSTRACT

A multilayer ceramic capacitor includes a portion where a first distance is greater than a second distance. The first distance is a distance between adjacent second internal electrode layers along a stacking direction and a distance between second internal electrode layers which, in first edge regions, overlap first internal electrode layers along the stacking direction. The second distance is a distance between adjacent first internal electrode layers along the stacking direction and a distance between the first internal electrode layers which, in first transition regions, do not overlap the second internal electrode layers along the stacking direction.

### CROSS REFERENCE TO RELATED APPLICATIONS

This application claims the benefit of priority to Japanese Patent Application No. 2022-212598 filed on Dec. 28, 2022 and is a Continuation Application of PCT Application No. PCT/JP2023/041870 filed on Nov. 21, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In the prior art, multilayer ceramic capacitors have been known which each include a multilayer body including a plurality of laminated dielectric layers and a plurality of internal electrode layers laminated on the dielectric layers, and a plurality of external electrodes.

Japanese Unexamined Patent Application, Publication No. 2004-47536 discloses a multilayer ceramic capacitor including internal electrode layers, each including an extension portion having a tapered portion with a width gradually decreasing with increasing proximity to an end surface.

However, in such a multilayer ceramic capacitor, the overlapping state of the plurality of internal electrode layers and the plurality of dielectric layers becomes complicated, and a step difference is likely to occur due to the thickness of the internal electrode layers.

Japanese Unexamined Patent Application, Publication No. 2004-349429 discloses a configuration in which an auxiliary layer is provided in a recessed portion formed by a step difference generated by the thickness of the internal electrode layers.

The auxiliary layer is provided so as to extend over the edge of the internal electrode layer in order to reduce the occurrence of defects caused by the recessed portion.

However, when the auxiliary layer is simply provided so as to extend over the edge of the internal electrode layer including the extension portion having the tapered portion, the overlapping state of the plurality of auxiliary layers becomes complicated, and a portion in which the thickness of the dielectric layer is partially reduced may be provided in the multilayer body after the pressing step and the firing step.

This may reduce the reliability of the multilayer ceramic capacitor.

Therefore, there is a need to develop multilayer ceramic capacitors that are each able to adjust the overlapping state between a plurality of internal electrode layers and a plurality of dielectric layers to reduce or prevent a decrease in reliability.

### SUMMARY OF THE INVENTION

Example embodiments of the present invention provide multilayer ceramic capacitors that are each able to adjust the overlapping state between a plurality of internal electrode layers and a plurality of dielectric layers to reduce or prevent a decrease in reliability.

The inventors of example embodiments of the present invention have discovered that, in a multilayer ceramic capacitor including a portion in which a first distance which is a distance between second internal electrode layers adjacent to each other in the lamination direction and a distance between the second internal electrode layers overlapping with a corresponding one of the plurality of first internal electrode layers in the lamination direction in the first edge region located adjacent to the first end surface between the second internal electrode layers, is longer than a second distance, which is a distance between first internal electrode layers adjacent to each other in the lamination direction and a distance between the first internal electrode layers not overlapping with any of the plurality of second internal electrode layers in the lamination direction T in the first transition region, it is possible to reduce or prevent a decrease in reliability.

An example embodiment of the present invention provides a multilayer ceramic capacitor which includes a multilayer body including a plurality of laminated dielectric layers, a plurality of internal electrode layers each laminated on a corresponding one of the plurality of dielectric layers, a first main surface and a second main surface opposed to each other in a lamination direction, a first end surface and a second end surface opposed to each other in a length direction orthogonal or substantially orthogonal to the lamination direction, and a first lateral surface and a second lateral surface opposed to each other in a width direction orthogonal or substantially orthogonal to the lamination direction and the length direction, and a plurality of external electrodes, in which the plurality of internal electrode layers include a plurality of first internal electrode layers and a plurality of second internal electrode layers, the plurality of first internal electrode layers each include a first counter portion opposed to a corresponding one of the plurality of second internal electrode layers with a corresponding one of the plurality of dielectric layers interposed therebetween, and a first extension portion extending from the first counter portion toward the first end surface of the multilayer body, the first extension portion includes a first transition region having a decreasing dimension in the width direction and a first extension region extending from the first transition region toward the first end surface and has a dimension in the width direction shorter than a length in the width direction of the first counter portion, the plurality of second internal electrode layers each include a first edge region located adjacent to the first end surface, and the multilayer ceramic capacitor includes a portion in which a first distance between adjacent second internal electrode layers in the lamination direction and between the plurality of second internal electrode layers overlapping with a corresponding one of the plurality of first internal electrode layers in the lamination direction in the first edge region, is greater than a second distance between adjacent first internal electrode layers in the lamination direction and between the plurality of first internal electrode layers not overlapping with any of the plurality of second internal electrode layers in the lamination direction in the first transition region.

According to example embodiments of the present invention, it is possible to provide multilayer ceramic capacitors that are each able to adjust the overlapping state between a plurality of internal electrode layers and a plurality of dielectric layers to reduce or prevent a decrease in reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a cross-sectional view taken along the line II-II in FIG. 1, and shows a half above a middle portion in the lamination direction T.

FIG. 3 is a cross-sectional view taken along the line III-III in FIG. 1, and shows a half above a middle portion in the lamination direction T.

FIG. 4 is a cross-sectional view of the multilayer ceramic capacitor 1 according to the first example embodiment of the present invention taken along the first internal electrode layer 15A.

FIG. 5 is a cross-sectional view of the multilayer ceramic capacitor 1 according to the first example embodiment of the present invention taken along the second internal electrode layer 15B.

FIG. 6 is a flowchart showing a method of manufacturing the multilayer ceramic capacitor 1 according to the first example embodiment of the present invention.

FIG. 7 is a process diagram showing a method of manufacturing the multilayer ceramic capacitor 1 according to the first example embodiment of the present invention.

FIG. 8 is a process diagram showing a method of manufacturing the multilayer ceramic capacitor 1 according to the first example embodiment of the present invention.

FIG. 9 is a process diagram showing a method of manufacturing the multilayer ceramic capacitor 1 according to the first example embodiment of the present invention.

FIG. 10 is a process diagram showing a method of manufacturing the multilayer ceramic capacitor 1 according to the first example embodiment of the present invention.

FIG. 11 is a process diagram showing a method of manufacturing the multilayer ceramic capacitor 1 according to the first example embodiment of the present invention.

FIG. 12 is a process diagram showing a method of manufacturing the multilayer ceramic capacitor 1 according to the first example embodiment of the present invention.

FIG. 13 is a schematic perspective view of a multilayer ceramic capacitor 200 according to a second example embodiment of the present invention.

FIG. 14 is a cross-sectional view of the multilayer ceramic capacitor 200 according to the second example embodiment of the present invention taken along the first internal electrode layer 15A.

FIG. 15 is a cross-sectional view of the multilayer ceramic capacitor 200 according to the second example embodiment of the present invention taken along the second internal electrode layer 15B.

FIG. 16 is a process diagram showing a method of manufacturing the multilayer ceramic capacitor 200 according to the second example embodiment of the present invention.

FIG. 17 is a process diagram showing a method of manufacturing the multilayer ceramic capacitor 200 according to the second example embodiment of the present invention.

FIG. 18 is a process diagram showing a method of manufacturing the multilayer ceramic capacitor 200 according to the second example embodiment of the present invention.

### DETAILED DESCRIPTION OF THE EXAMPLE EMBODIMENTS

Example embodiments of the present invention will be described in detail below with reference to the drawings.

### Multilayer Ceramic Capacitor 1

Hereinafter, a multilayer ceramic capacitor 1 will be described as a first example embodiment of the present invention.

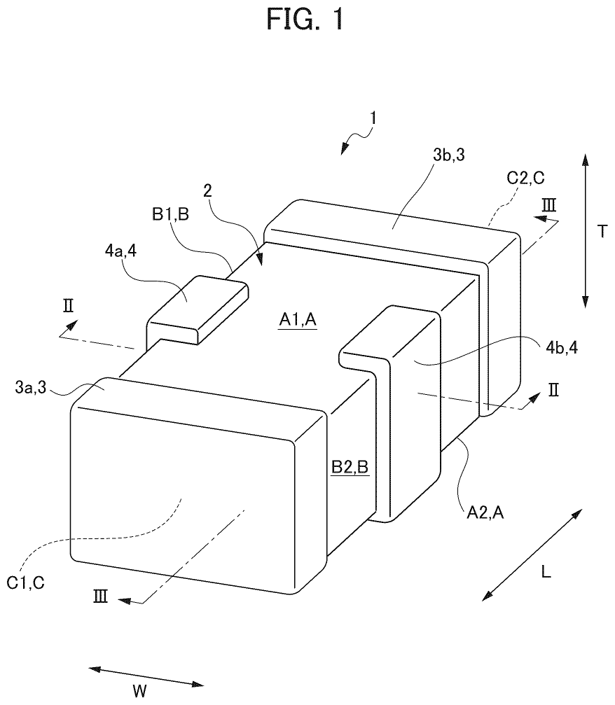

FIG. 1 is a schematic perspective view of a multilayer ceramic capacitor 1.

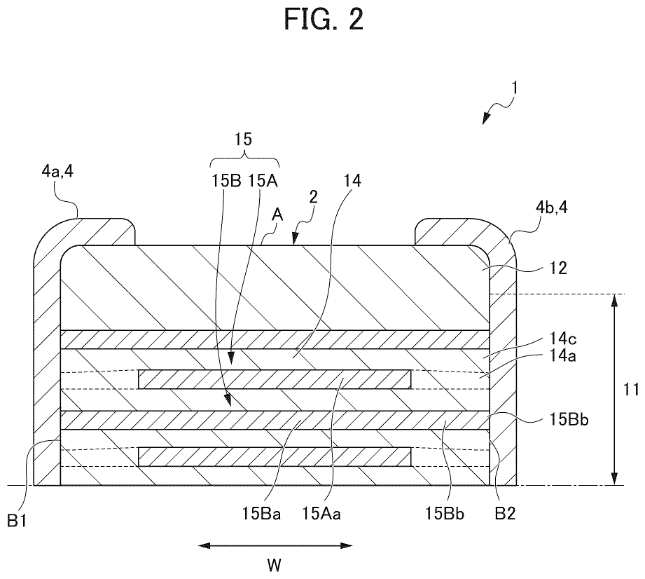

FIG. 2 shows a state of a cross section of the multilayer ceramic capacitor 1 taken along the line II-II in FIG. 1 and defined by the width direction W and the lamination direction T (WT cross-section), and shows a half above the middle portion in the lamination direction T.

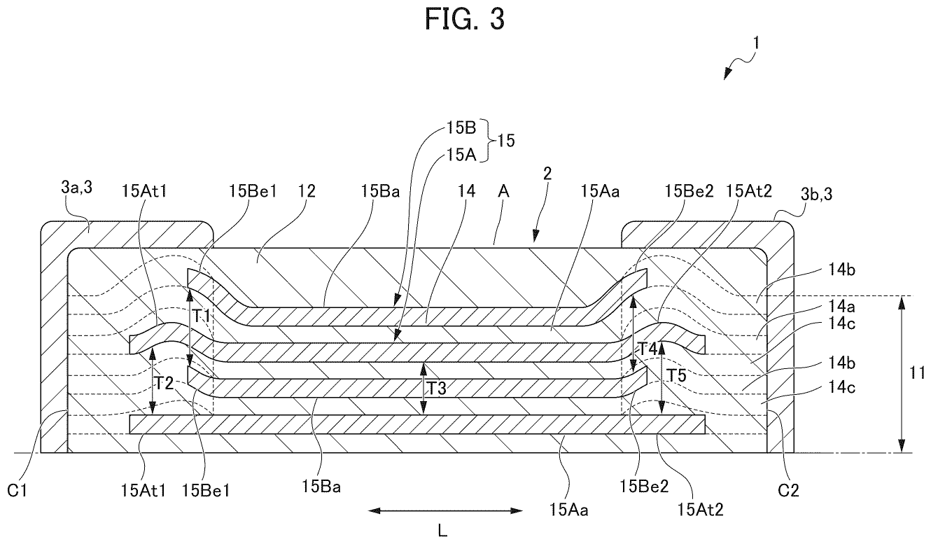

FIG. 3 shows a state of a cross section (LT cross section) of the multilayer ceramic capacitor 1 taken along the line III-III in FIG. 1 and defined by the length direction L and the lamination direction T, and shows a half above the middle portion in the lamination direction T.

The line II-II is a line passing through the middle portion in the length direction L of the multilayer ceramic capacitor 1.

The line III-III is a line that passes through an area in which first internal electrode layers 15A and second internal electrode layers 15B of the multilayer ceramic capacitor 1 described later are laminated, but does not pass through a first extension region 15Aw1 of a first extension portion 15Ab1 of each of the first internal electrode layers 15A and a second extension region 15Aw2 of the second extension portion 15Ab2 of each of the first internal electrode layers 15A.

While example embodiments will be described, these example embodiments will be described by way of example only, and are not intended to limit the scope of the present invention.

Further, it is possible to combine or substitute the features described in different example embodiments, and such configurations are also included in the present invention.

In addition, the drawings are for aiding in understanding of the specification and may be schematically drawn, and the drawn components or the ratio of the dimensions between the components may not necessarily coincide with the ratio of the dimensions described in the specification.

In addition, components described in the specification may be omitted in the drawings or may be drawn with the number of components omitted.

The multilayer ceramic capacitor 1 includes end surface external electrodes 3 provided on both end surfaces C of the multilayer body 2 in the length direction L, and lateral surface external electrodes 4 provided on both lateral surfaces B of the multilayer body 2 in the width direction W.

The multilayer body 2 includes an inner layer portion 11 including a plurality of sets of dielectric layers 14 and internal electrode layers 15, and an outer layer portion 12.

The dimensions of the multilayer ceramic capacitor 1 are not particularly limited, but may be, for example, about 0.6 mm or more and about 3.2 mm or less in the length direction L, about 0.3 mm or more and about 2.5 mm or less in the lamination direction T, and about 0.3 mm or more and about 2.5 mm or less in the width direction W.

In the present specification, as a term representing the orientation of the multilayer ceramic capacitor 1, a direction in which the dielectric layers 14 and the internal electrode layers 15 are laminated in the multilayer ceramic capacitor 1 is defined as a lamination direction T.

A direction intersecting the lamination direction T and in which the pair of end surface external electrodes 3 are provided is defined as a length direction L.

A direction intersecting both the length direction L and the lamination direction T is defined as a width direction W.

In the example embodiment, the lamination direction T, the length direction L, and the width direction W are orthogonal or substantially orthogonal to each other.

### Multilayer Body 2

The multilayer body 2 includes an inner layer portion 11 and outer layer portions 12 provided on both sides of the inner layer portion 11 in the lamination direction T.

The multilayer body 2 preferably includes rounded corner portions and rounded ridge portions.

The corner portions each refer to a portion where the three surfaces of the multilayer body intersect with one another, and the ridge line portions each refer to a portion where the two surfaces of the multilayer body intersect with each other.

The dimensions of the multilayer body 2 are not particularly limited, but may be, for example, about 0.6 mm or more and about 3.2 mm or less in the length direction L, about 0.3 mm or more and about 2.5 mm or less in the lamination direction T, and about 0.3 mm or more and about 2.5 mm or less in the width direction W.

### Inner Layer Portion 11

In the inner layer portion 11, a plurality of dielectric layers 14 and a plurality of internal electrode layers 15 are laminated along the lamination direction T.

### Dielectric Layer 14

The dielectric layers 14 are each made of a ceramic material.

As the ceramic material, for example, a dielectric ceramic including BaTiO₃ as a main component is used.

Further, as the ceramic material, for example, a material obtained by adding at least one subcomponent such as a Mn compound, a Fe compound, a Cr compound, a Co compound, or a Ni compound to these main components may be used.

The dielectric layers 14 include dielectric layers 14c manufactured from a ceramic green sheet 114 described later, and dielectric layers 14a and 14b manufactured from ceramic pastes 114a and 114b applied on the ceramic green sheet 114.

### Internal Electrode Layer 15

The internal electrode layers 15 are each preferably made of a metal material such as, for example, Ni, Cu, Ag, Pd, an Ag—Pd alloy, Au, or other materials.

The thickness of each of the internal electrode layers 15 is not particularly limited, but is, for example, preferably about 0.25 μm or more and about 0.6 μm or less, and more preferably about 0.3 μm or more and about 0.5 μm or less.

For example, fourteen or more and 1000 or less internal electrode layers 15 can be embedded in the inner layer portion 11.

The internal electrode layers 15 include first internal electrode layers 15A and second internal electrode layers 15B that are alternately provided. The first internal electrode layers 15A and the second internal electrode layers 15B generate capacitance via the dielectric layers 14 in first counter portions 15Aa and second counter portions 15Ba that overlap each other in a plan view from the lamination direction T.

### First Internal Electrode Layer 15A

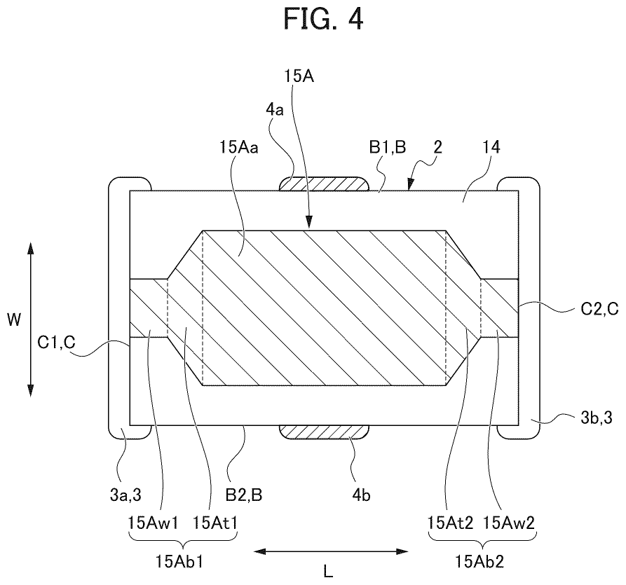

FIG. 4 is a cross-sectional view of the multilayer ceramic capacitor 1 taken along the first internal electrode layer 15A.

As shown in FIG. 4, the first internal electrode layer 15A extends between both end surfaces C in the length direction L of the multilayer body 2, and is spaced apart from both lateral surfaces B in the width direction W by a certain distance.

The first internal electrode layer 15A includes a rectangular or substantially rectangular first counter portion 15Aa that is spaced apart from both end surfaces C by a certain distance and is opposed to a second counter portion 15Ba of a corresponding one of the second internal electrode layers 15B described later with a corresponding one of the dielectric layers 14 interposed therebetween, and a first extension portion 15Ab1 and a second extension portion 15Ab2 extending from the first counter portion 15Aa to the first end surface C1 and the second end surface C2, respectively.

The first extension portion 15Ab1 includes a trapezoidal first transition region 15At1 having a dimension in the width direction W gradually decreasing with increasing proximity to the first end surface C1, and a first extension region 15Aw1 extending from the first transition region 15At1 toward the first end surface C1.

The second extension portion 15Ab2 includes a trapezoidal second transition region 15At2 having a dimension in the width direction W gradually decreasing with increasing proximity to the second end surface C2, and a second extension region 15Aw2 extending from the second transition region 15At2 toward the second end surface C2.

The first extension region 15Aw1 and the second extension region 15Aw2 are exposed at the first end surface C1 and the second end surface C2, respectively, and are connected to the first end surface external electrode 3a and the second end surface external electrode 3b, respectively.

In the first internal electrode layer 15A, the dimension in the width direction W of each of the first extension region 15Aw1 of the first extension portion 15Ab1 and the second extension region 15Aw2 of the second extension portion 15Ab2 is shorter than the dimension in the width direction W of the first counter portion 15Aa.

As described above, by shortening the dimensions of the first extension region 15Aw1 and the second extension region 15Aw2 in the width direction W, it is possible to reduce or prevent moisture infiltration from the outside, and thus it is possible to improve the reliability of the multilayer ceramic capacitor.

### Second Internal Electrode Layer 15B

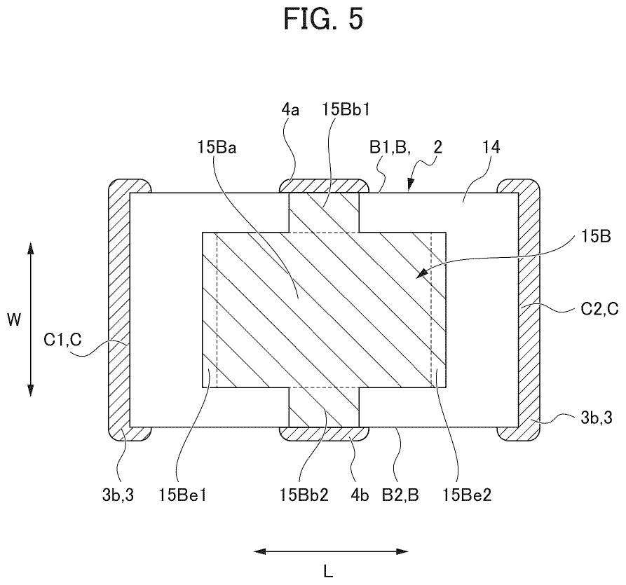

FIG. 5 is a cross-sectional view of the multilayer ceramic capacitor 1 taken along the second internal electrode layer 15B.

As shown in FIG. 5, the second internal electrode layer 15B has a rectangular or substantially rectangular second counter portion 15Ba that is slightly smaller than the multilayer body 2 and includes sides spaced apart from the end surface C and the lateral surface B by a certain distance, and a first extension portion 15Bb1 and a second extension portion 15Bb2 that extend from the second counter portion 15Ba toward the first lateral surface B1 and the second lateral surface B2, respectively.

In addition, the second counter portion 15Ba includes a first edge region 15Be1 along one side adjacent to the first end surface C1 and a second edge region 15Be2 along one side adjacent to the second end surface C2.

The first extension portion 15Bb1 and the second extension portion 15Bb2 are exposed at the first lateral surface B1 and the second lateral surface B2 of the multilayer body 2, respectively, and are connected to the first lateral surface external electrode 4a and the second lateral surface external electrode 4b, respectively.

In the second internal electrode layer 15B, the dimension in the length direction L of each of the first extension portion 15Bb1 and the second extension portion 15Bb2 is shorter than the dimension in the length direction L of the second counter portion 15Ba.

As described above, by shortening the dimensions of the first extension portion 15Bb1 and the second extension portion 15Bb2 in the length direction L, it is possible to reduce or prevent moisture infiltration from the outside, and thus it is possible to improve the reliability of the multilayer ceramic capacitor.

### Outer Layer Portion 12

As shown in FIGS. 2 and 3, the outer layer portion 12 is a dielectric layer having a certain thickness provided on the first main surface A1 and the second main surface A2 of the inner layer portion 11.

The outer layer portion 12 is made of the same material as the dielectric layer 14 of the inner layer portion 11.

The thickness of the dielectric layer is not particularly limited, but is, for example, preferably about 0.3 μm or more and about 1.5 μm or less, and more preferably about 0.5 μm or more and about 1 μm or less.

The multilayer body 2 including the inner layer portion 11 and the outer layer portion 12 may include, for example, 14 or more and 1000 or less dielectric layers.

### End Surface External Electrode 3

The first end surface external electrode 3a is provided on the first end surface C1 of the multilayer body 2, and the second end surface external electrode 3b is provided on the second end surface C2.

The first extension portion 15Ab1 of the first internal electrode layer 15A is connected to the first end surface external electrode 3a.

The second extension portion 15Ab2 of the first internal electrode layer 15A is connected to the second end surface external electrode 3b.

The first end surface external electrode 3a and the second end surface external electrode 3b cover not only the first end surface C1 and the second end surface C2, respectively, but also a portion of the first main surface A1, a portion of the second main surface A2, a portion of the first lateral surface B1, and a portion of the second lateral surface B2.

### Lateral Surface External Electrode 4

A first lateral surface external electrode 4a and a second lateral surface external electrode 4b are provided on the first lateral surface B1 and the second lateral surface B2, respectively, of the multilayer body 2.

The first extension portion 15Bb1 of the second internal electrode layer 15B is connected to the first lateral surface external electrode 4a, and the second extension portion 15Bb2 of the second internal electrode layer 15B is connected to the second lateral surface external electrode 4b.

The first lateral surface external electrode 4a and the second lateral surface external electrode 4b cover not only the first lateral surface B1 and the second lateral surface B2, but also a portion of the first main surface A1 and a portion of the second main surface A2, respectively.

The multilayer ceramic capacitor 1 in which the first internal electrode layer 15A is connected to the first end surface external electrode 3a and the second end surface external electrode 3b, and the second internal electrode layer 15B is connected to the first lateral surface external electrode 4a and the second lateral surface external electrode 4b can be used as a three-terminal capacitor.

That is, the multilayer ceramic capacitor 1 can be used as a three-terminal capacitor by interrupting midway a power line or a signal line in a circuit, connecting the first end surface external electrode 3a to one of the interrupted portions, connecting the second end surface external electrode 3b to the other of the interrupted portions, and connecting the first lateral surface external electrode 4a and the second lateral surface external electrode 4b to ground.

In this case, the second internal electrode layer 15A defines and functions as a through electrode, and the first internal electrode layer 15B defines and functions as a ground electrode.

Each of the end surface external electrodes 3 and each of the lateral surface external electrodes 4 may include, for example, a configuration including a base electrode layer and a plated layer provided on the base electrode layer.

The base electrode layer includes at least one layer selected from, for example, a fired layer, an electrically conductive resin layer, a direct plated layer, and other layers as described below.

### Fired Layer

The fired layer is formed by applying an electrically conductive paste including glass and metal to the multilayer body and firing the paste, and may be formed by co-firing the paste with the internal electrode layers, or may be formed by firing the paste after firing the internal electrode layers.

The temperature of the firing treatment is, for example, preferably about 700° C. to about 900° C.

The glass component includes, for example, at least one of B, Si, Ba, Mg, Al, Li, or other components.

The metal includes, for example, at least one of Cu, Ni, Ag, Pd, an Ag—Pd alloy, Au, or other metals.

The thickness of the fired layer is preferably, for example, about 3 μm or more and about 70 μm or less.

The fired layer may include a plurality of layers.

### Electrically Conductive Resin Layer

The electrically conductive resin layer is provided on the surface of the fired layer or directly on the surface of the multilayer body.

The electrically conductive resin layer may include a plurality of layers.

As an example of a method of forming the electrically conductive resin layer, an electrically conductive resin paste including a thermosetting resin and a metal component is applied onto the fired layer or the multilayer body, and heat treatment is performed at a temperature of, for example, about 250° C. to about 550° C. or higher to thermally cure the resin, thus forming the electrically conductive resin layer.

At this time, the atmosphere during the heat treatment is, for example, preferably an N₂ atmosphere.

Further, in order to prevent scattering of the resin and oxidation of various metal components, the oxygen concentration is, for example, about 100 ppm or less.

The thickness of the electrically conductive resin layer in the middle portion of the end surface C is preferably about 10 μm or more and about 150 μm or less, for example.

As the resin of the electrically conductive resin layer, for example, various known thermosetting resins such as an epoxy resin, a phenol resin, a urethane resin, a silicone resin, or a polyimide resin may be used.

Among them, an epoxy resin excellent in heat resistance, moisture resistance, adhesion, and the like is one suitable resin.

The resin included in the electrically conductive resin layer is, for example, preferably included in an amount of about 25 vol % or more and about 65 vol % or less with respect to the total volume of the electrically conductive resin.

Further, the electrically conductive resin layer preferably includes a curing agent together with a thermosetting resin.

When an epoxy resin is used as the base resin, various known compounds such as, for example, phenol-based compounds, amine-based compounds, acid anhydride-based compounds, or imidazole-based compounds can be used as the curing agent of the epoxy resin.

Since the electrically conductive resin layer includes a thermosetting resin, the electrically conductive resin layer is more flexible than, for example, a plating film or an electrically conductive layer made of a fired product of an electrically conductive paste.

For this reason, even when a physical impact or shock due to thermal cycling is applied to the ceramic electronic component, the electrically conductive resin layer defines and functions as a buffer layer, and cracks in the ceramic electronic component can be prevented.

As the metal included in the electrically conductive resin layer, for example, Ag, Cu, or an alloy thereof can be used.

Alternatively, for example, a metal powder including a surface coated with Ag may be used.

When an Ag-coated metal powder is used, for example, Cu or Ni is preferably used as the metal powder.

Alternatively, for example, Cu subjected to an antioxidant treatment may be used.

The reason why the electrically conductive metal powder of Ag is used as the electrically conductive metal is that Ag is suitable for an electrode material because it has a low specific resistance, and furthermore, Ag is a noble metal and is not oxidized and has a high counteracting property.

The reason why the Ag-coated metal is used is that the metal of the base material can be inexpensively made, while maintaining the above-described characteristics of Ag.

The metal included in the electrically conductive resin layer is, for example, preferably included in an amount of about 35 vol % or more and about 75 vol % or less with respect to the total volume of the electrically conductive resin.

The shape of the metal included in the electrically conductive resin layer is not particularly limited.

The electrically conductive filler may have a spherical shape, a flat shape, or other shapes.

The average particle diameter of the metal included in the electrically conductive resin layer is not particularly limited, but may be, for example, about 0.3 μm or more and about 10 μm or less.

The metal included in the electrically conductive resin layer is mainly responsible for the electrical conductivity of the electrically conductive resin layer.

Specifically, when the electrically conductive fillers are in contact with each other, an electrical conduction path is provided inside the electrically conductive resin layer.

### Plated Layer

A plated layer may be directly provided on each of the end surfaces of the multilayer body where the internal electrode layers are exposed.

That is, the multilayer ceramic capacitor may include a configuration including a plated layer electrically connected directly to the internal electrode layers and the surface electrode layer.

In such a case, the direct plated layer may be provided after the catalyst is provided on the surface of the multilayer body as a pretreatment.

The plated layer preferably includes, for example, at least one metal of Cu, Ni, Sn, Pb, Au, Ag, Pd, Bi, or Zn, or an alloy including the metal.

For example, when the first internal electrode layers and the second internal electrode layers are made using Ni, the direct plated layer is preferably made using Cu having good bonding property with Ni.

The thickness per plated layer is, for example, preferably about 2 μm or more and about 15 μm or less.

The plated layer preferably does not include glass.

The metal ratio per unit volume of the plated layer is, for example, preferably about 99% by volume or more.

When plating is performed, either electrolytic plating or electroless plating may be used, but electroless plating requires pretreatment with a catalyst or the like in order to improve the plating deposition rate, and thus has the disadvantage of complicating the process.

Therefore, in general, electrolytic plating is preferably used.

As the plating method, for example, barrel plating is preferably used.

If necessary, an upper plating electrode provided on the surface of the lower plating electrode may be similarly formed.

When the base electrode layer is a thin film layer, the thin film layer is formed by a thin film forming method such as, for example, a sputtering method or a vapor deposition method, and is a layer having a thickness of about 1 μm or less on which metal particles are deposited.

The plated layer provided on the base electrode layer includes, for example, at least one of Cu, Ni, Ag, Pd, an Ag—Pd alloy, Au, or the like.

The plated layer may include a plurality of layers.

For example, a two-layer configuration of Ni plating and Sn plating is preferable.

The Ni plated layer can prevent the base electrode layer from being eroded by the solder when the ceramic electronic component is mounted, and the Sn plated layer can improve the wettability of the solder when the ceramic electronic component is mounted, which facilitates the mounting.

The thickness per one plated layer is, for example, preferably about 2 μm or more and about 15 μm or less.

As shown in FIG. 3, the first distance T1 is defined as a distance between the second internal electrode layers 15B adjacent to each other in the lamination direction T and is also defined as a distance between the second internal electrode layers overlapping with the first internal electrode layer 15A in the lamination direction T in the first edge region 15Be1. The second distance T2 is defined as a distance between the first internal electrode layers 15A adjacent to each other in the lamination direction T and is also defined as a distance between the first internal electrode layers not overlapping with the second internal electrode layer 15B in the lamination direction T in the first transition region 15At1. The multilayer ceramic capacitor includes a portion in which the first distance T1 is longer than the second distance T2.

The third distance T3 is defined as a distance between the first internal electrode layers 15A adjacent to each other in the lamination direction T, and is also defined as a distance between the first internal electrode layers 15A overlapping with the second internal electrode layer 15B in the lamination direction T in the middle region of the first counter portion 15Aa. The multilayer ceramic capacitor includes a portion in which the first distance T1 is longer than the third distance T3.

A similar relationship among the first distance T1, the second distance T2, and the third distance T3 is provided on the opposite side adjacent to the second end surface C2. That is, a fourth distance T4 is defined as a distance between the second internal electrode layers 15B adjacent to each other in the lamination direction T and is also defined as a distance between the second internal electrode layers 15B overlapping with the first internal electrode layers 15A in the lamination direction T in the second edge region 15Be2. A fifth distance T5 is defined as a distance between the first internal electrode layers 15A adjacent to each other in the lamination direction T, and is also defined as a distance between the first internal electrode layers not overlapping with the second internal electrode layer 15B in the lamination direction T in the second transition region 15At2. The multilayer ceramic capacitor includes a portion in which the fourth distance T4 is longer than the fifth distance T5.

Further, the third distance T3 is defined as a distance between the first internal electrode layers 15A adjacent to each other in the lamination direction T, and is also defined as a distance between the first internal electrode layers 15A overlapping with the second internal electrode layer 15B in the lamination direction T in the middle region of the first counter portion 15Aa. The multilayer ceramic capacitor includes a portion in which the fourth distance T4 is longer than the third distance T3.

The first distance T1, the second distance T2, the third distance T3, the fourth distance T4, and the fifth distance T5 can be measured by, for example, polishing the multilayer ceramic capacitor 1 at an angle in parallel or substantially in parallel with the lateral surface B along the line III-III shown in FIG. 1 to expose a cross section, and observing the cross section using a scanning electron microscope.

Specifically, the measurement of the first distance T1 is performed on a cross section obtained by polishing the multilayer ceramic capacitor 1 to a position where the cross section is located at a position about one half of the dimension in the width direction of the multilayer ceramic capacitor 1 at an angle perpendicular or substantially perpendicular to the dimension in the width direction.

In the above-described cross section, by dividing the cross section into three regions so that the thickness dimension of the inner layer portion is divided into three equal or substantially equal portions, the dimensions of the first distance T1 at 20 locations from each region are measured using a scanning microscope (SEM).

Finally, an average value thereof is taken and defined as a first distance T1.

Similarly, by dividing the cross section into three regions so that the thickness dimension of the inner layer portion is divided into three equal or substantially equal portions, the dimensions of the second distance T2 at 20 locations from each region are measured using a scanning microscope (SEM).

Finally, an average value thereof is taken and defined as a second distance T2.

Similarly, by dividing the cross section into three regions so that the thickness dimension of the inner layer portion is divided into three equal or substantially equal portions, the dimensions of the third distance T3 at 20 locations from each region are measured using a scanning microscope (SEM).

Finally, an average value thereof is taken and defined as a third distance T3.

Similarly, by dividing the cross section into three regions so that the thickness dimension of the inner layer portion is divided into three equal or substantially equal portions, the dimensions of the fourth distance T4 at 20 locations from each region are measured using a scanning microscope (SEM).

Finally, an average value thereof is taken and defined as a fourth distance T4.

Similarly, the fifth distance T5 is divided into three regions so that the thickness dimension of the inner layer portion is divided into three equal or substantially equal portions in the above-described cross section, and the dimensions of T5 at 20 locations from each region are measured using a scanning microscope (SEM).

Finally, an average value thereof is taken and defined as a fifth distance T5.

For example, the first distance T1 is preferably about 1.5 μm or more and about 8.2 μm or less, the second distance T2 is preferably about 1.1 μm or more and about 7.2 μm or less, the third distance T3 is preferably about 1.1 μm or more and about 5.0 μm or less, the fourth distance T4 is preferably about 1.5 μm or more and about 8.2 μm or less, and the fifth distance T5 is preferably about 1.1 μm or more and about 7.2 μm or less.

### Manufacturing Method of Multilayer Ceramic Capacitor 1

Next, an example of a method of manufacturing the multilayer ceramic capacitor 1 will be described.

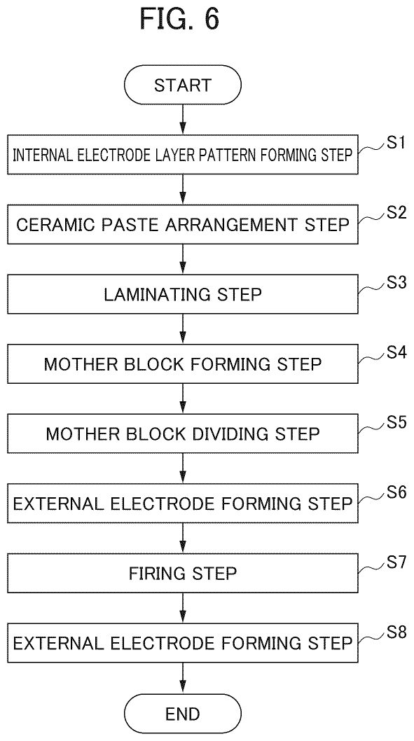

FIG. 6 is a flowchart showing a method of manufacturing the multilayer ceramic capacitor 1.

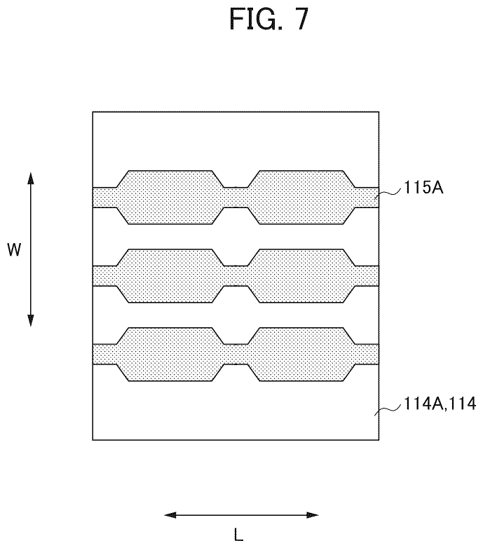

FIGS. 7 to 12 are process diagrams showing the manufacturing method.

### Internal Electrode Layer Pattern Forming Step S1

First, as shown in FIG. 7, a first internal electrode layer pattern 115A defining and functioning as the first internal electrode layer 15A is formed from an electrically conductive paste on a first ceramic green sheet 114A defining and functioning as a dielectric layer 14c.

The first internal electrode layer pattern 115A has a shape in which the plurality of first internal electrode layers 15A are continuous in the length direction L, but discontinuous in the width direction W.

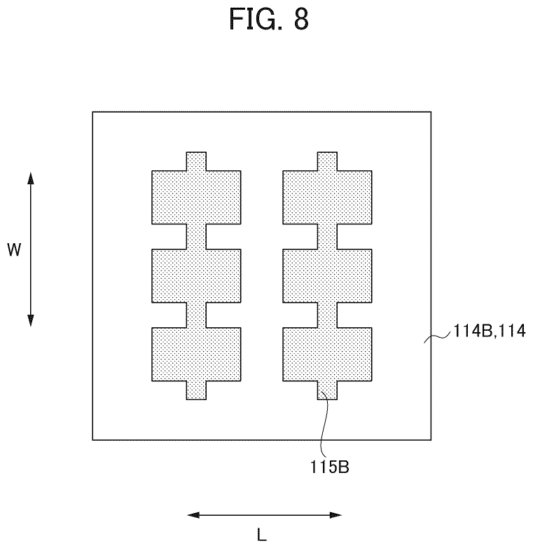

As shown in FIG. 8, a second internal electrode layer pattern 115B defining and functioning as the second internal electrode layer 15B is formed from an electrically conductive paste on a second ceramic green sheet 114B defining and functioning as the dielectric layer 14c.

The second internal electrode layer pattern 115B has a shape in which the plurality of second internal electrode layers 15B are continuous in the width direction W, but discontinuous in the length direction L.

The ceramic green sheet 114 is a band-shaped sheet in which a ceramic slurry including ceramic powder, a binder, and a solvent is formed into a sheet shape on a carrier film using, for example, a die coater, a gravure coater, a microgravure coater, or the like.

The first internal electrode layer pattern 115A and the second internal electrode layer pattern 115B are formed by, for example, printing such as screen printing, gravure printing, or relief printing.

### Ceramic Paste Arrangement Step S2

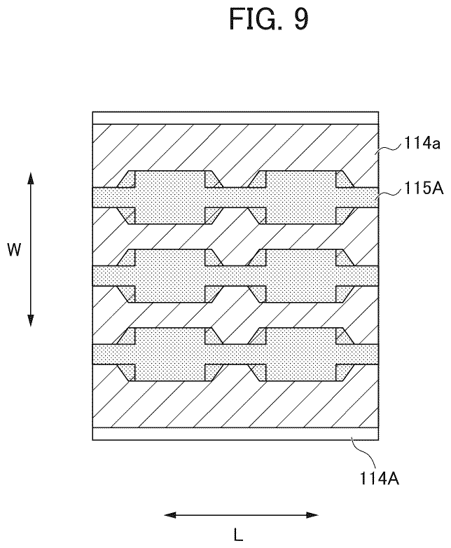

Next, as shown in FIG. 9, a ceramic paste 114a for forming the dielectric layer 14a is coated on the sheet in which the first internal electrode layer pattern 115A is formed on the first ceramic green sheet 114A shown in FIG. 7.

The thickness of the dielectric layer 14a is, for example, about 0.4 to about 0.8 times the thickness of the dielectric layer 14c.

In the first example embodiment, the ceramic paste 114a fills the entire or substantially the entire portion of the first ceramic green sheet 114A where the first internal electrode layer pattern 115A is not provided. Further, on both sides of the first internal electrode layer 15A in the length direction L, the ceramic paste 114a is provided so as to overlap an area in which a virtual region connecting the first extension region 15Aw1 and the second extension region 15Aw2 is excluded from a region corresponding to the first transition region 15At1 and a portion of the first counter portion 15Aa adjacent to the first end surface C1 overlapping with the first edge region 15Be1 of the second internal electrode layer 15B in a plan view from the lamination direction T, and from a region corresponding to the second transition region 15At2 and a portion of the first counter portion 15Aa adjacent to the second end surface C2 overlapping with the second edge region 15Be2 of the second internal electrode layer 15B in a plan view from the lamination direction T.

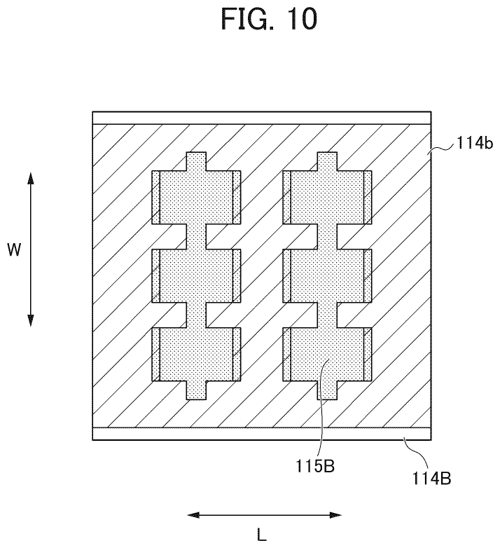

Further, as shown in FIG. 10, the ceramic paste 114b defining and functioning as the dielectric layer 14b is coated on the sheet in which the second internal electrode layer pattern 115B is formed on the second ceramic green sheet 114B shown in FIG. 8.

The thickness of the dielectric layer 14b is, for example, about 0.4 to about 0.8 times the thickness of the dielectric layer 14c.

In the first example embodiment, the ceramic paste 114b fills the entire or substantially the entire portion of the second ceramic green sheet 114B where the second internal electrode layer pattern 115B is not provided, and is provided so as to overlap portions corresponding to the first edge region 15Be1 and the second edge region 15Be2 on both side edges of the second counter portion 15Ba of the second internal electrode layer pattern 115B in the length direction L.

Although the ceramic paste 114a forms the dielectric layer 14a and the ceramic paste 114b forms the dielectric layer 14b, when these layers are laminated through the laminating step S3 described later, the tip position of the dielectric layer 14a overlapping with the first internal electrode layer 15A and the tip position of the dielectric layer 14b overlapping with the second internal electrode layer 15B coincide with each other in a plan view from the lamination direction T, as shown in the LT cross section shown in FIG. 3.

The ceramic paste 114a and the ceramic paste 114b are applied by printing such as, for example, screen printing, gravure printing, or relief printing.

The ceramic pastes 114a and 114b may have different component ratios from the dielectric as the material of the ceramic green sheet 114, may have the same component ratio, or may include different components.

### Laminating Step S3

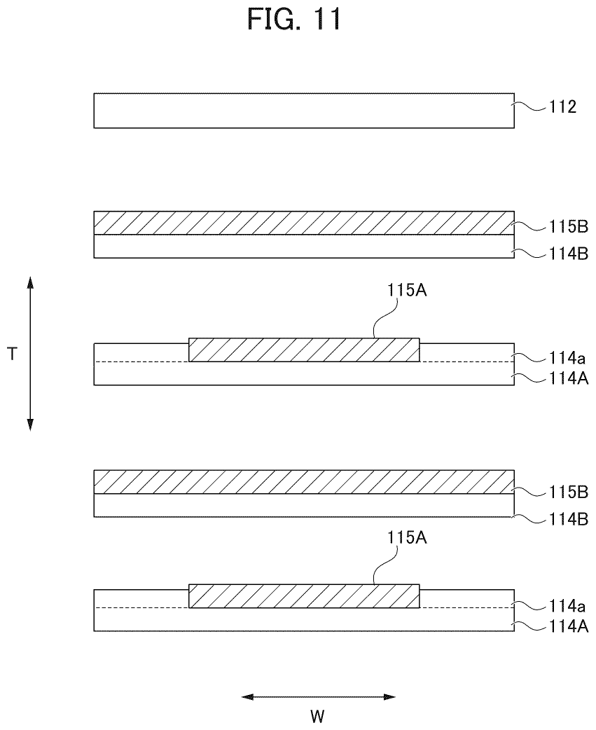

FIG. 11 is a diagram showing the laminated state of the multilayer body 2 in the WT cross section at the middle in the length direction L.

For convenience of description, FIG. 11 schematically shows a state in which a plurality of ceramic green sheets to be laminated are separated from each other.

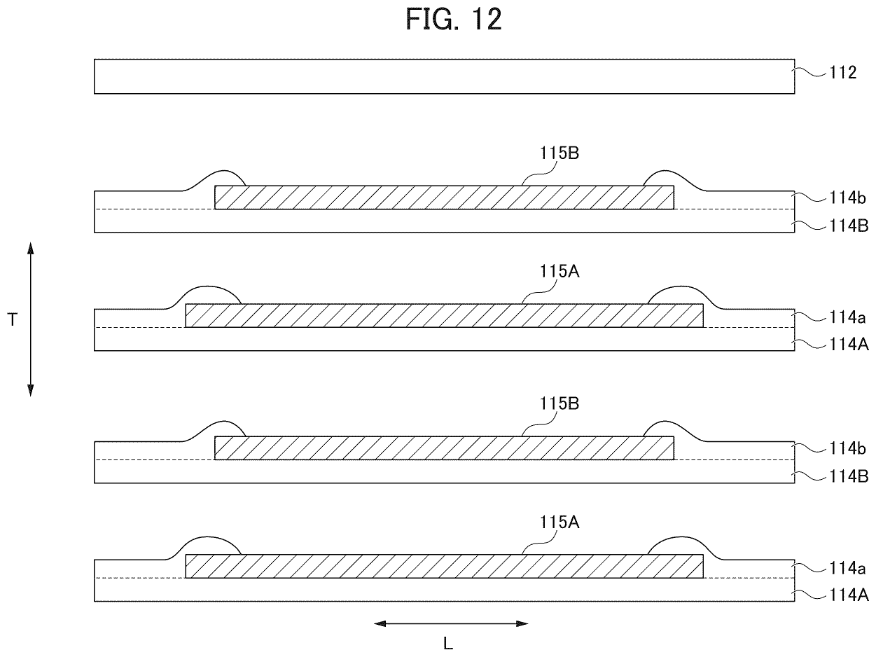

The same applies to FIGS. 12, 17, and 18.

As illustrated, a sheet in which the first internal electrode layer pattern 115A and the ceramic paste 114a are provided on the first ceramic green sheet 114A shown in FIG. 9 and a sheet in which the second internal electrode layer pattern 115B and the ceramic paste 114b are provided on the second ceramic green sheet 114B shown in FIG. 10 are alternately laminated.

The ceramic paste 114a forms a dielectric layer 14a.

The ceramic paste 114b also forms a dielectric layer 14b.

Both of the first internal electrode layer pattern 115A and the second internal electrode layer pattern 115B extend in the width direction W with a constant interval in the lamination direction T.

FIG. 12 is a diagram showing the laminated state of the multilayer body 2 in the LT cross section taken along the line III-III in FIG. 1.

In FIG. 12, the ceramic paste 114a covers upper portions of both ends of the first internal electrode layer pattern 115A in the length direction L.

Similarly, the ceramic paste 114b covers upper portions of both ends of the second internal electrode layer pattern 115B in the length direction L.

The ceramic paste 114a forms the dielectric layer 14a.

The ceramic paste 114b forms the dielectric layer 14b.

Further, the ceramic green sheets 112 for manufacturing the outer layer portion defining and functioning as the outer layer portions 12 are laminated on both sides of the laminated product in the lamination direction T.

### Mother Block Forming Step S4

The ceramic green sheet 112 for manufacturing the outer layer portion and a plurality of laminated sheets are thermocompression-bonded to form a mother block.

### Mother Block Dividing Step S5

Next, the mother block is cut and divided in the length direction L and the width direction W to manufacture a plurality of rectangular or substantially rectangular multilayer bodies 2.

### External Electrode Forming Step S6

Next, the end surface external electrodes 3 are formed on both end surfaces C of the multilayer body 2, and the lateral surface external electrodes 4 are formed on both lateral surfaces B of the multilayer body 2.

The first extension portion 15Ab1 of each of the first internal electrode layers 15A is connected to the first end surface external electrode 3a, and the second extension portion 15Ab2 of each of the first internal electrode layers 15A is connected to the second end surface external electrode 3b.

The end surface external electrode 3 is formed so as to cover not only the end surface C, but also a portion of the main surface A and a portion of the lateral surface B adjacent to the end surface C.

The first extension portion 15Bb1 of each of the second internal electrode layers 15B is connected to the first lateral surface external electrode 4a, and the second extension portion 15Bb2 of each of the second internal electrode layers 15B is connected to the second lateral surface external electrode 4b.

The lateral surface external electrode 4 is formed so as to cover not only a portion of the lateral surface B, but also a portion of the main surface adjacent to the lateral surface B.

### Firing Step S7

Then, heating is performed for a predetermined period of time in a nitrogen atmosphere at the set firing temperature.

With such a configuration, the external electrodes are fired on the multilayer body 2, and the multilayer ceramic capacitor 1 shown in FIG. 1 is manufactured.

In the firing step, the multilayer chip is subjected to a binder removal treatment and a firing treatment to form a base body portion (the multilayer body 2).

The electrically conductive paste layer and the dielectric layer green sheet are co-sintered by firing to form the internal electrode layer 15 and the dielectric layer 14, respectively.

The conditions of the binder removal treatment may be determined according to the type of the organic binder included in the green sheet and the electrically conductive paste layer.

The firing treatment may be performed at a temperature at which the multilayer chip is sufficiently densified.

The firing temperature is, for example, preferably about 900° C. to about 1400° C., although it depends on the materials of the dielectric and the internal electrode layers.

In the WT cross section taken along the line II-II of the multilayer body 2, as shown in FIG. 2, both the first internal electrode layers 15A and the second internal electrode layers 15B extend in the width direction W with a constant interval in the lamination direction T.

### External Electrode Forming Step S8

A plated layer is provided as necessary.

In the present example embodiment, for example, the Ni plated layer and the Sn plated layer are formed on the fired layer.

The Ni plated layer and the Sn plated layer are sequentially formed by barrel plating, for example.

With such a configuration, it is possible to obtain the multilayer ceramic capacitor 1.

### Multilayer Ceramic Capacitor 200

As a second example embodiment of the present invention, a multilayer ceramic capacitor 200 will be described.

Hereinafter, a configuration and an example of a manufacturing method of the multilayer ceramic capacitor 200 will be described with a focus on portions different from the multilayer ceramic capacitor 1.

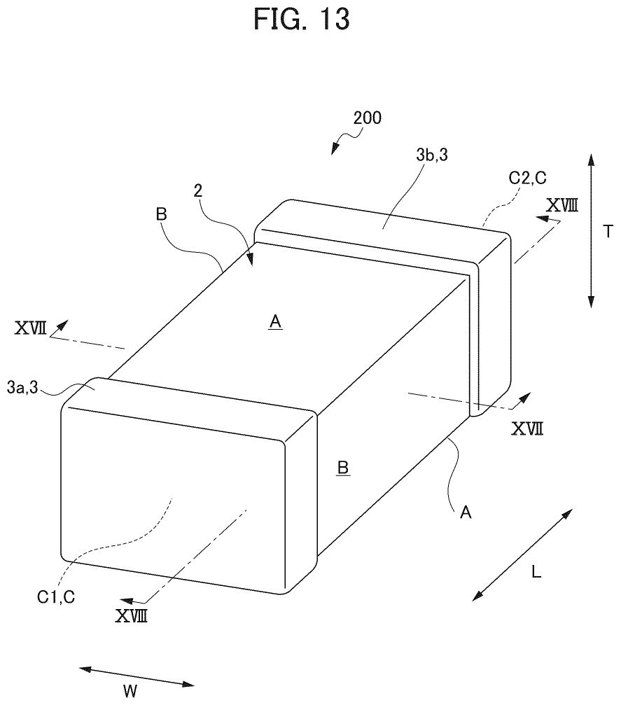

FIG. 13 is a schematic perspective view of the multilayer ceramic capacitor 200.

In the drawings, the line XVII-XVII is a line passing through a middle portion of the multilayer ceramic capacitor 200 in the length direction L.

Further, the line XVIII-XVIII is a line passing through an area in which the first internal electrode layers 15A and the second internal electrode layers 15B of the multilayer ceramic capacitor 200 described later are laminated, but not passing through the first extension region 15Aw1 of the first extension portion 15Ab1 of each of the first internal electrode layers 15A and the second extension region 15Aw2 of the second extension portion 15Bb2 of each of the second internal electrode layers 15B.

### End Surface External Electrode 3

The first end surface external electrode 3a is provided on the first end surface C1 of the multilayer body 2, and the second end surface external electrode 3b is provided on the second end surface C2 of the multilayer body 2.

The first extension portion 15Ab1 of each of the first internal electrode layers 15A is connected to the first end surface external electrode 3a.

The second extension portion 15Bb2 of each of the second internal electrode layers 15B is connected to the second end surface external electrode 3b.

The first end surface external electrode 3a and the second end surface external electrode 3b cover not only the first end surface C1 and the second end surface C2, respectively, but also a portion of the first main surface A1, a portion of the second main surface A2, a portion of the first lateral surface B1, and a portion of the second lateral surface B2.

### First Internal Electrode Layer 15A

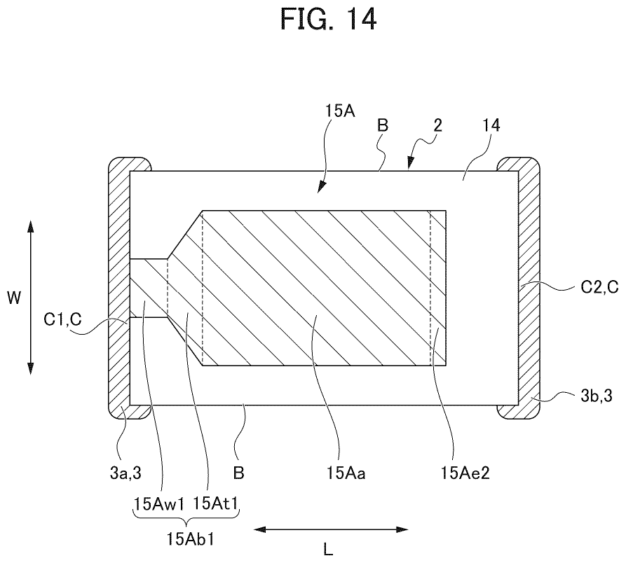

FIG. 14 is a cross-sectional view of the multilayer ceramic capacitor 200 taken along a first internal electrode layer 15A.

As shown in FIG. 14, the first internal electrode layer 15A includes a rectangular first counter portion 15Aa in the middle opposed to a second counter portion 15Ba of a second internal electrode layer 15B described later with the dielectric layer 14 interposed therebetween, and a first extension portion 15Ab1 extending from the first counter portion 15Aa toward the first end surface C1.

The first extension portion 15Ab1 includes a trapezoidal first transition region 15At1 having a dimension in the width direction W gradually decreasing with increasing proximity to the first end surface C1, and a first extension region 15Aw1 extending from the first transition region 15At1 toward the first end surface C1.

The first extension region 15Aw1 is exposed at the first end surface C1 and is connected to the first end surface external electrode 3a.

The first counter portion 15Aa includes a second edge region 15Ae2 along one side of the first counter portion 15Aa adjacent to the second end surface C2.

In the first internal electrode layer 15A, the dimension of the first extension region 15Aw1 of the first extension portion 15Ab1 in the width direction W is shorter than the dimension of the first counter portion 15Aa in the width direction W.

As described above, by shortening the dimension of the first extension region 15Aw1 in the width direction W, it is possible to reduce or prevent moisture infiltration from the outside, such that it is possible to improve the reliability of the multilayer ceramic capacitor.

### Second Internal Electrode Layer 15B

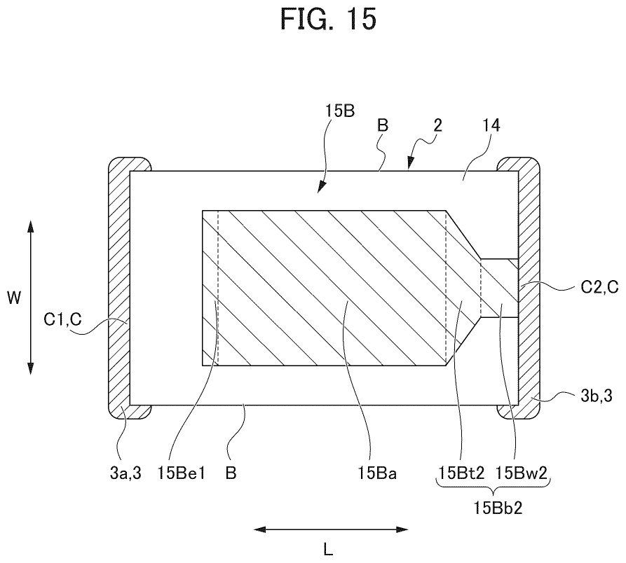

FIG. 15 is a cross-sectional view of the multilayer ceramic capacitor 200 taken along the second internal electrode layer 15B.

As shown in FIG. 15, the second internal electrode layer 15B includes a rectangular or substantially rectangular second counter portion 15Ba in the middle opposed to the first counter portion 15Aa of the first internal electrode layer 15A with the dielectric layer 14 interposed therebetween, and a second extension portion 15Bb2 extending from the second counter portion 15Ba toward the second end surface C2.

The second extension portion 15Bb2 includes a trapezoidal second transition region 15Bt2 having a dimension in the width direction W gradually decreasing with increasing proximity to the second end surface C2, and a second extension region 15Bw2 extending from the second transition region 15Bt2 toward the second end surface C2.

The second extension region 15Bw2 is exposed at the first end surface C1 and is connected to the first end surface external electrode 3a.

The second counter portion 15Ba includes a first edge region 15Be1 along one side of the second counter portion 15Ba adjacent to the first end surface C1.

In the second internal electrode layer 15B, the dimension of the second extension region 15Bw2 of the second extension portion 15Bb2 in the width direction W is shorter than the dimension of the second counter portion 15Ba in the width direction W.

In this manner, by shortening the dimension of the second extension region 15Bw2 in the width direction W, it is possible to reduce or prevent moisture infiltration from the outside, such that it is possible to improve the reliability of the multilayer ceramic capacitor.

It is possible to use, as a two-terminal capacitor, the multilayer ceramic capacitor 200 in which the first internal electrode layer 15A is connected to the first end surface external electrode 3a and the second internal electrode layer 15B is connected to the second end surface external electrode 3b.

### Ceramic Paste Arrangement Step S2

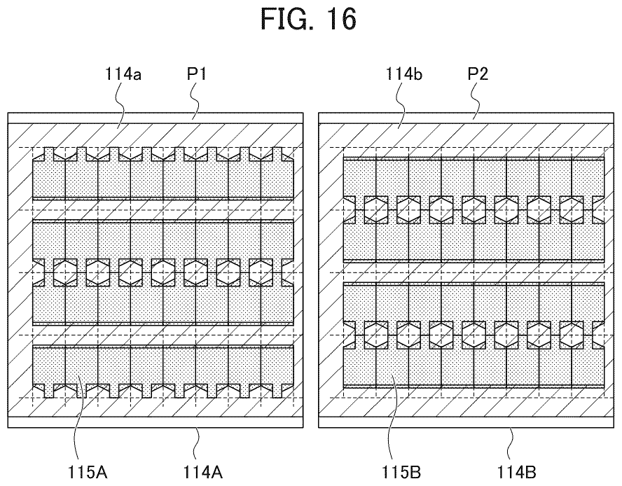

FIG. 16 shows two patterns in which internal electrode layers are printed.

The two patterns show a state in which a ceramic paste for forming a dielectric layer is applied on a sheet in which an internal electrode layer pattern is formed on a ceramic green sheet.

Since the first internal electrode layer 15A and the second internal electrode layer 15B have the same or substantially the same shape, they are not distinguished from each other at the time of manufacturing.

Pattern P1 shows a state in which the ceramic paste 114a is applied to a sheet on which the first internal electrode layer pattern 115A forming the first internal electrode layer 15A or the second internal electrode layer 15B is printed on the first ceramic green sheet 114A.

The ceramic paste 114a forms the dielectric layer 14a or the dielectric layer 14b.

Pattern P2 shows a state in which the ceramic paste 114b is applied to a sheet on which the second internal electrode layer pattern 115B forming the first internal electrode layer 15A or the second internal electrode layer 15B is formed on the second ceramic green sheet 114B.

The ceramic paste 114b forms the dielectric layer 14a or the dielectric layer 14b.

The pattern P1 and the pattern P2 differ from each other in the positions of the first internal electrode layer pattern 115A and the second internal electrode layer pattern 115B respectively provided on the first ceramic green sheet 114A and the second ceramic green sheet 114B. When the pattern P1 and the pattern P2 are alternately laminated, the first internal electrode layer 15A and the second internal electrode layer 15B are alternately formed.

In the drawings, the pattern P1 and the pattern P2 are shown with reference to dotted lines indicating positions to be cut after laminating.

In the pattern P1, the ceramic paste 114a fills the entire or substantially the entire portion of the first ceramic green sheet 114A where the first internal electrode layer pattern 115A is not provided. Further, in the first internal electrode layer 15A, the ceramic paste 114a is provided to overlap with an area from which a virtual region defined by the first extension region 15Aw1 extending in the length direction L is excluded from a region corresponding to a portion of the first counter portion 15Aa overlapping with the first edge region 15Be1 of the second internal electrode layer 15B and adjacent to the first end surface C1 in a plan view from the lamination direction T, and the first transition region 15At1, and a region corresponding to the second edge region 15Ae2. Further, in the second internal electrode layer 15B, the ceramic paste 114a is provided to overlap with an area from which a virtual region defined by the second extension region 15Bw2 extending in the length direction L is excluded from a region corresponding to a portion of the second counter portion 15Ba overlapping with the second edge region 15Ae2 of the first internal electrode layer 15A in a plan view from the lamination direction T and adjacent to the second end surface C2, and the second transition region 15Bt2, and a region corresponding to the first edge region 15Be1.

Similarly, in the pattern P2, the ceramic paste 114b fills the entire or substantially the entire portion of the second ceramic green sheet 114B where the second internal electrode layer pattern 115B is not provided. Further, in the first internal electrode layer 15A, the ceramic paste 114b is provided to overlap with an area from which a virtual region defined by the first extension region 15Aw1 extending in the length direction L is excluded from a region corresponding to a portion of the first counter portion 15Aa overlapping with first edge region 15Be1 of the second internal electrode layer 15B in a plan view from the lamination direction T and adjacent to the first end surface C1, and the first transition region 15At1, and a region corresponding to the second edge region 15Ae2. Further, in the second internal electrode layer 15B, the ceramic paste 114b is provided to overlap with an area from which a virtual region defined by the second extension region 15Bw2 extending in the length direction L is excluded from a region corresponding to a portion of the second counter portion 15Ba overlapping with the second edge region 15Ae2 of the first internal electrode layer 15A in a plan view from the lamination direction T, and adjacent to the second end surface C2, and the second transition region 15Bt2, and a region corresponding to the first edge region 15Be1.

The ceramic green sheets 112 for manufacturing the outer layer portion defining and functioning as the outer layer portion 12 are further laminated on both sides in the lamination direction T of the laminated product in which the first ceramic green sheets 114A printed in the pattern P1 and the second ceramic green sheets 114B printed in the pattern P2 are alternately laminated.

The ceramic green sheets 112 for manufacturing the outer layer portion and a plurality of laminated sheets are pressed in the lamination direction by, for example, isostatic pressing or the like to produce a multilayer block.

Next, the multilayer block is cut into a predetermined size to cut out multilayer chips.

Dielectric sheets for manufacturing the first side margin portion W11 and the second side margin portion W12 are attached to the lateral surfaces of each of the multilayer chips.

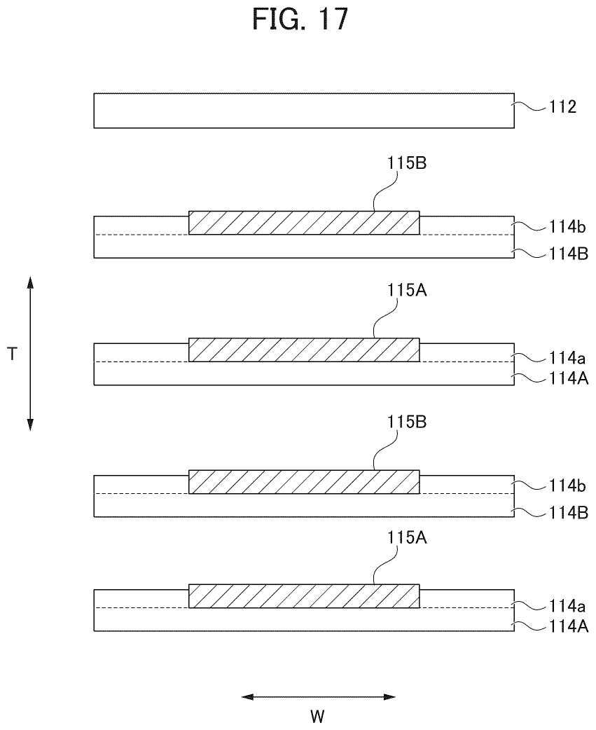

FIG. 17 is a view for explaining a laminated state of the multilayer body 2 in the WT cross section of the multilayer ceramic capacitor 200 cut along the line XVII-XVII shown in FIG. 13.

The line XVII-XVII is a line passing through a middle portion in the length direction L of the multilayer ceramic capacitor 200.

As illustrated, the sheet of the pattern P1 in which the first internal electrode layer pattern 115A and the ceramic paste 114a are provided on the first ceramic green sheet 114A shown in FIG. 16, and the sheet of the pattern P2 in which the second internal electrode layer pattern 115B and the ceramic paste 114b are provided on the second ceramic green sheet 114B are alternately laminated.

Both of the first internal electrode layer pattern 115A and the second internal electrode layer pattern 115B extend in the width direction W with a constant distance in the lamination direction T.

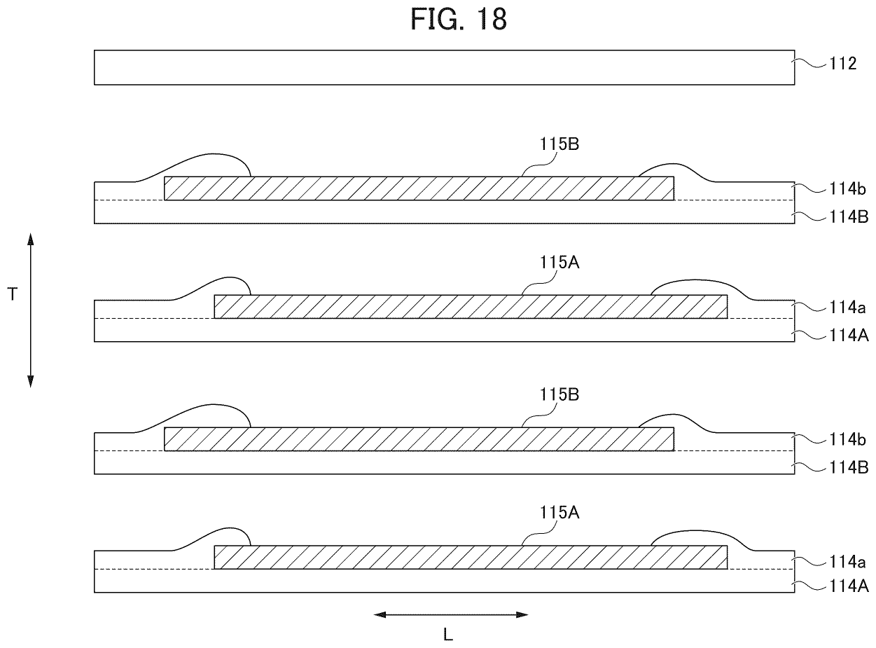

FIG. 18 is a view for explaining a laminated state of the multilayer body 2 in the LT cross section of the multilayer ceramic capacitor 200 cut along the line XVIII-XVIII shown in FIG. 13.

The line XVIII-XVIII is a line passing through an area in which the first internal electrode layers 15A and the second internal electrode layers 15B of the multilayer ceramic capacitor 200 are laminated, but not passing through the first extension region 15Aw1 of the first extension portion 15Ab1 of each of the first internal electrode layers 15A and the second extension region 15Bw2 of the second extension portion 15Bb2 of each of the second internal electrode layers 15B.

In FIG. 18, the ceramic paste 114a covers upper portions of both ends of the first internal electrode layer pattern 115A in the length direction L.

Similarly, the ceramic paste 114b covers upper portions of both ends of the second internal electrode layer pattern 115B in the length direction L.

The ceramic paste 114a forms the dielectric layer 14a.

The ceramic paste 114b forms the dielectric layer 14b.

The laminated state shown in FIG. 18 corresponds to FIG. 12 of the first example embodiment, and a cross section taken along the line XVIII-XVIII of the multilayer ceramic capacitor 200 in FIG. 13 forms a cross section corresponding to FIG. 3 of the first example embodiment.

Therefore, it is possible to obtain the same or substantially the same advantageous effects as those of the first example embodiment also in the second example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated dielectric layers, a plurality of internal electrode layers each laminated on a corresponding one of the plurality of dielectric layers, a first main surface and a second main surface opposed to each other in a lamination direction, a first end surface and a second end surface opposed to each other in a length direction orthogonal or substantially orthogonal to the lamination direction, and a first lateral surface and a second lateral surface opposed to each other in a width direction orthogonal or substantially orthogonal to the lamination direction and the length direction; and
a plurality of external electrodes; wherein
the plurality of internal electrode layers include a plurality of first internal electrode layers and a plurality of second internal electrode layers;
the plurality of first internal electrode layers each include a first counter portion opposed to a corresponding one of the plurality of second internal electrode layers with a corresponding one of the plurality of dielectric layers interposed therebetween, and a first extension portion extending from the first counter portion toward the first end surface of the multilayer body;
the first extension portion includes a first transition region having a dimension decreasing in the width direction, and a first extension region extending from the first transition region toward the first end surface and has a dimension in the width direction shorter than a dimension in the width direction of the first counter portion;
the plurality of second internal electrode layers each include a first edge region located adjacent to the first end surface; and
the multilayer ceramic capacitor includes a portion in which a first distance between adjacent second internal electrode layers in the lamination direction and between the plurality of second internal electrode layers overlapping with a corresponding one of the plurality of first internal electrode layers in the lamination direction in the first edge region, is greater than a second distance between adjacent first internal electrode layers in the lamination direction and between the plurality of first internal electrode layers not overlapping with any of the plurality of second internal electrode layers in the lamination direction in the first transition region.

2. The multilayer ceramic capacitor according to claim 1, wherein the multilayer ceramic capacitor includes a portion in which the first distance is greater than a third distance between the adjacent first internal electrode layers in the lamination direction and between the plurality of first internal electrode layers overlapping with a corresponding one of the plurality of second internal electrode layers in the lamination direction in a middle region of the first counter portion.

3. The multilayer ceramic capacitor according to claim 1, wherein
the plurality of first internal electrode layers each further include a second extension portion extending from the first counter portion toward the second end surface of the multilayer body;
the plurality of second internal electrode layers each include a second counter portion opposed to a corresponding one of the plurality of first internal electrode layers with a corresponding one of the plurality of dielectric layers interposed therebetween, and a first extension portion extending from the second counter portion toward the first lateral surface of the multilayer body;
a length of the multilayer ceramic capacitor in the length direction is greater than a width of the ceramic capacitor in the width direction; and
the plurality of external electrodes include a first end surface external electrode connected to the first extension portion of each of the plurality of first internal electrode layers, a second end surface external electrode connected to the second extension portion of each of the plurality of first internal electrode layers, and a first lateral surface external electrode connected to the first extension portion of each of the plurality of second internal electrode layers.

4. The multilayer ceramic capacitor according to claim 1, wherein
the plurality of second internal electrode layers each include a second counter portion opposed to a corresponding one of the plurality of first internal electrode layers via a corresponding one of the plurality of dielectric layers, and a second extension portion extending from the second counter portion toward the second end surface of the multilayer body; and
the plurality of external electrodes include a first end surface external electrode connected to the first extension portion of each of the plurality of first internal electrode layers and a second end surface external electrode connected to the second extension portion of each of the plurality of second internal electrode layers.

5. The multilayer ceramic capacitor according to claim 1, wherein the first distance is about 1.5 μm or more and about 8.2 μm or less.

6. The multilayer ceramic capacitor according to claim 1, wherein the second distance is about 1.1 μm or more and about 7.2 μm or less.

7. The multilayer ceramic capacitor according to claim 5, wherein the second distance is about 1.1 μm or more and about 7.2 μm or less.

8. The multilayer ceramic capacitor according to claim 3, wherein the first distance is about 1.5 μm or more and about 8.2 μm or less.

9. The multilayer ceramic capacitor according to claim 3, wherein the second distance is about 1.1 μm or more and about 7.2 μm or less.

10. The multilayer ceramic capacitor according to claim 2, wherein the third distance is about 1.1 μm or more and about 5.0 μm or less.

11. The multilayer ceramic capacitor according to claim 1, wherein a fourth distance which is defined as a distance between the second internal electrode layers adjacent to each other in the lamination direction and is also defined as a distance between the second internal electrode layers overlapping with the first internal electrode layers in the lamination direction in the second edge region is longer than a fifth distance which is defined as a distance between the first internal electrode layers adjacent to each other in the lamination direction and is also defined as a distance between the first internal electrode layers not overlapping with the second internal electrode layer in the lamination direction in the second transition region.

12. The multilayer ceramic capacitor according to claim 11, wherein the fourth distance is about 1.5 μm or more and about 8.2 μm or less.

13. The multilayer ceramic capacitor according to claim 11, wherein the fifth distance is about 1.1 μm or more and about 7.2 μm or less.

14. The multilayer ceramic capacitor according to claim 2, wherein a fourth distance which is defined as a distance between the second internal electrode layers adjacent to each other in the lamination direction and is also defined as a distance between the second internal electrode layers overlapping with the first internal electrode layers in the lamination direction in the second edge region is longer than a fifth distance which is defined as a distance between the first internal electrode layers adjacent to each other in the lamination direction and is also defined as a distance between the first internal electrode layers not overlapping with the second internal electrode layer in the lamination direction in the second transition region.

15. The multilayer ceramic capacitor according to claim 14, wherein the fourth distance is longer than the third distance.
